(19) United States
(12) Patent Application Publication
(10) Pub. No.: US 2016/0096285 A1
(43) Pub. Date: Apr. 7, 2016

(54) Bucket Mixing System

(71) Applicant: James H. Page, Bottineau, ND (US)

(72) Inventor: James H. Page, Bottineau, ND (US)

(21) Appl. No.: 14/503,573

(22) Filed: Oct. 1, 2014

(51) Int. Cl. B28C 5/42

(52) U.S. Cl. CPC B28C 5/4203; B28C 5/4282; B28C 5/4286

(57) ABSTRACT

A bucket mixing system to aid in mixing a stabilizing agent with a material within an excavator-mounted bucket. The bucket mixing system generally includes a bucket which includes a built-in mixer adapted to mix materials and expel them through a plurality of vents within the lower surface of the bucket. A hydraulic motor is secured to the bucket which drives a drive assembly. The drive assembly is secured so as to rotate a central rod from which a plurality of anchors and mixers extend radially. Auger linkages are interwoven through the anchors and mixers to form a flexible auger configuration. The mixers may rotated bi-directionally to mix materials within the bucket and to expel mixed materials through the vents.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a bucket mixing unit and more specifically it relates to a bucket mixing system to aid in mixing a stabilizing agent with a material within an excavator-mounted bucket.

2. Description of the Related Art

Any discussion of the related art throughout the specification should in no way be considered as an admission that such related art is widely known or forms part of common general knowledge in the field.

Mixing buckets are known in the art for such application as mixing concrete or cement mixtures within a bucket. Additionally, buckets for other applications such as screening and crushing materials have been introduced. Most of these bucket applications are self-fed and they lack a flexible auger arrangement which aids in mixing materials and preventing build-up on the inner walls of the bucket.

While the present invention is directed to a wide variety of materials, it is primarily suited for use processing oil well waste mud with stabilizers such as fly ash, saw dust, lime fines, etc. The well waste mud stabilizer process is one in which the mixed materials, by nature and necessity, dry very quickly when mixed. In the past, such characteristics of the mixed materials have led to plugging and jamming of machinery due to the rapidity of the drying.

Because of the inherent problems with the related art, there is a need for a new and improved bucket mixing system to aid in mixing a stabilizing agent with a material within an excavator-mounted bucket.

### BRIEF SUMMARY OF THE INVENTION

The invention generally relates to a bucket mixing unit which includes a bucket which includes a built-in mixer adapted to mix materials and expel them through a plurality of vents within the lower surface of the bucket. A hydraulic motor is secured to the bucket which drives a drive assembly. The drive assembly is secured so as to rotate a central rod from which a plurality of anchors and mixers extend radially. Auger linkages are interwoven through the anchors and mixers to form a flexible auger configuration. The mixers may rotated bi-directionally to mix materials within the bucket and to expel mixed materials through the vents.

There has thus been outlined, rather broadly, some of the features of the invention in order that the detailed description thereof may be better understood, and in order that the present contribution to the art may be better appreciated. There are additional features of the invention that will be described hereinafter and that will form the subject matter o f the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention secured to a loading arm.

FIG. 2 is an upper perspective view of the present invention.

FIG. 3 is a top perspective view of the present invention.

FIG. 4 is a frontal view of the present invention.

FIG. 5 is a rear view of the present invention.

FIG. 6 is a top view of the present invention.

FIG. 7 is a bottom view of the present invention.

FIG. 8 is a first side view of the present invention.

FIG. 9 is a second side view of the present invention.

FIG. 10 is a side cutaway view of the present invention.

FIG. 11 is a side cutaway view of the present invention in use.

FIG. 12 is a frontal view of an exemplary anchor for use with the present invention.

FIG. 13 is a frontal view of a raked mixer for use with the present invention.

FIG. 14 is a frontal view of a straight-edged mixer for use with the present invention.

FIG. 15 is a frontal view of a first plate cover for use with the present invention.

FIG. 16 is a frontal view of a second plate cover for use with the present invention.

### DETAILED DESCRIPTION OF THE INVENTION

### A. Overview.

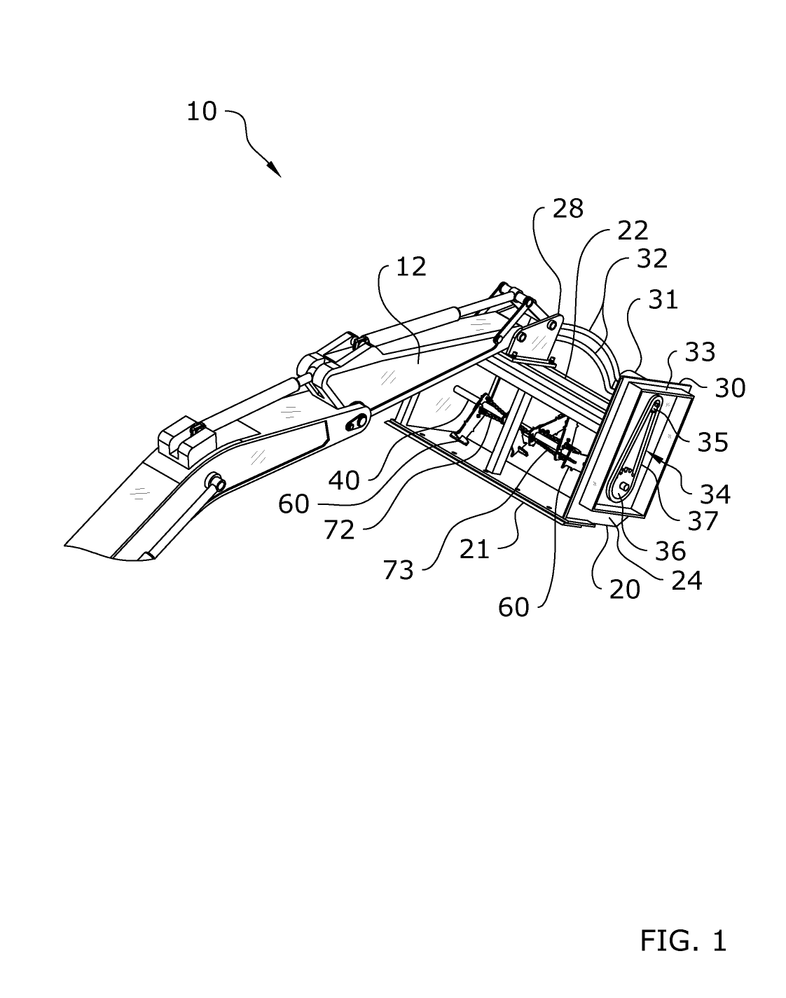

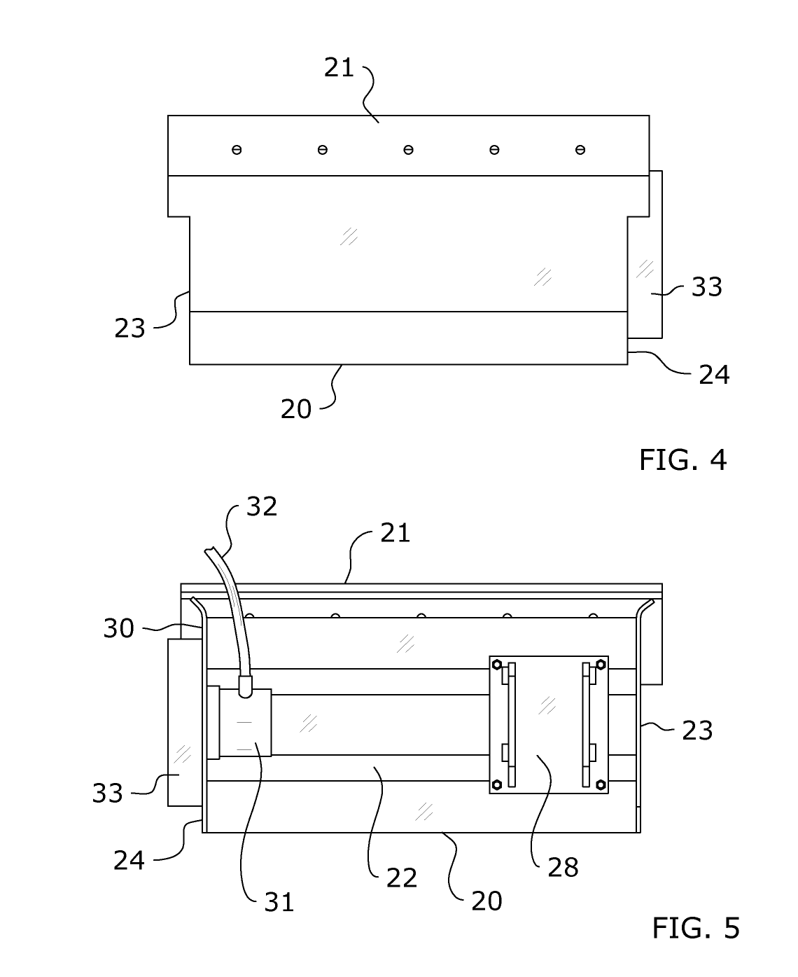

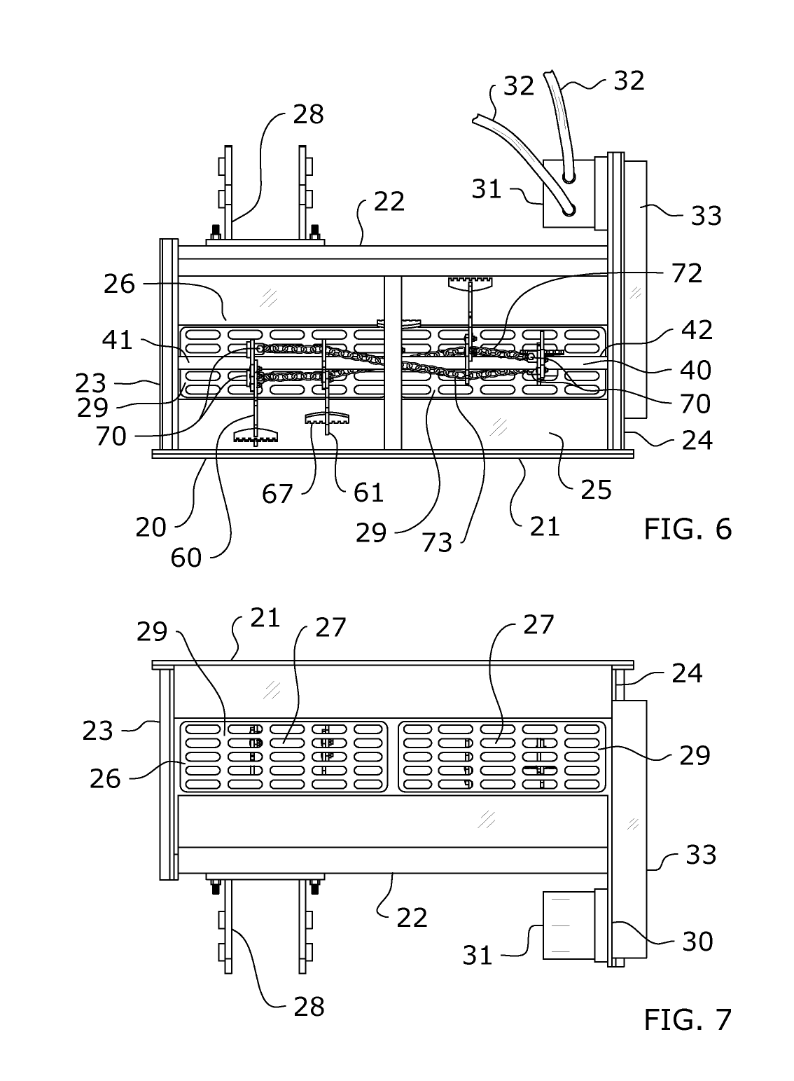

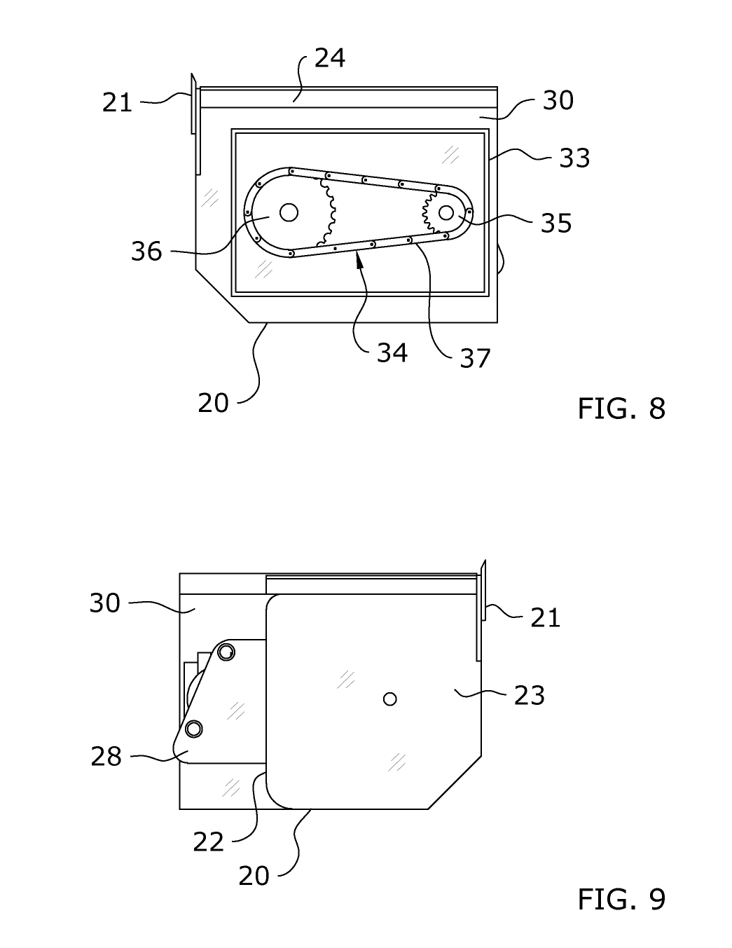

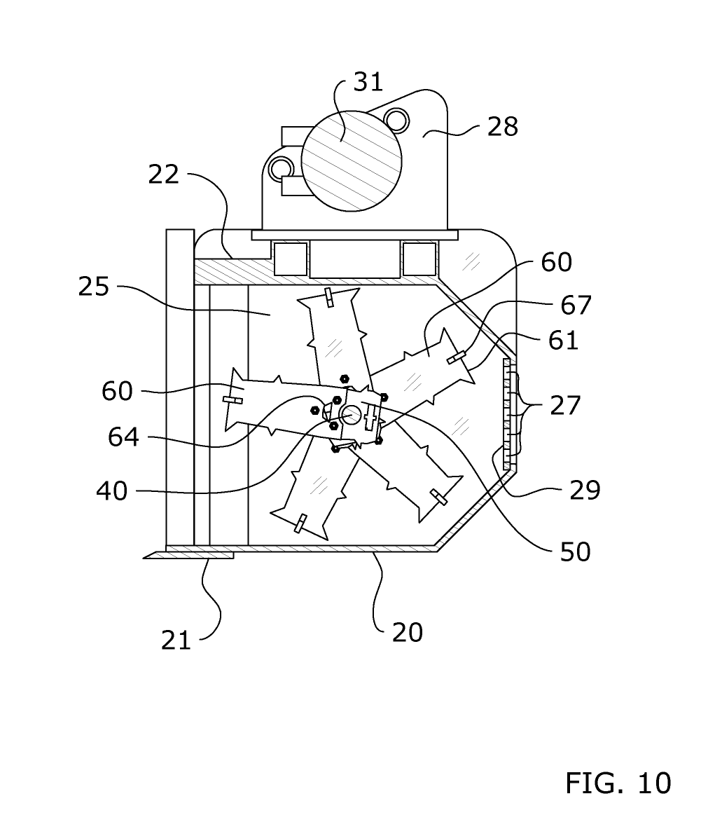

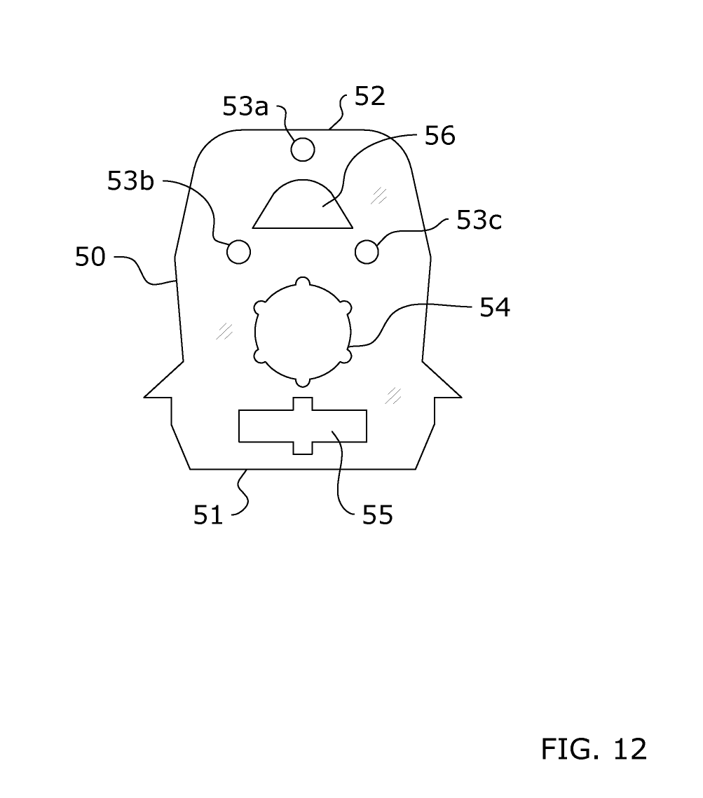

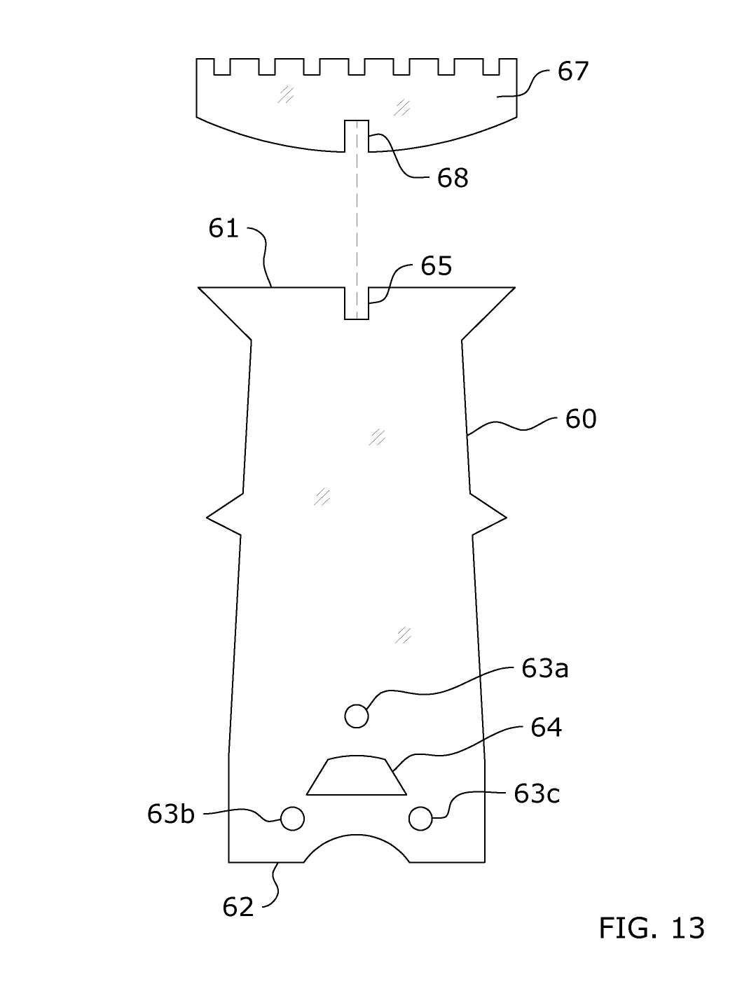

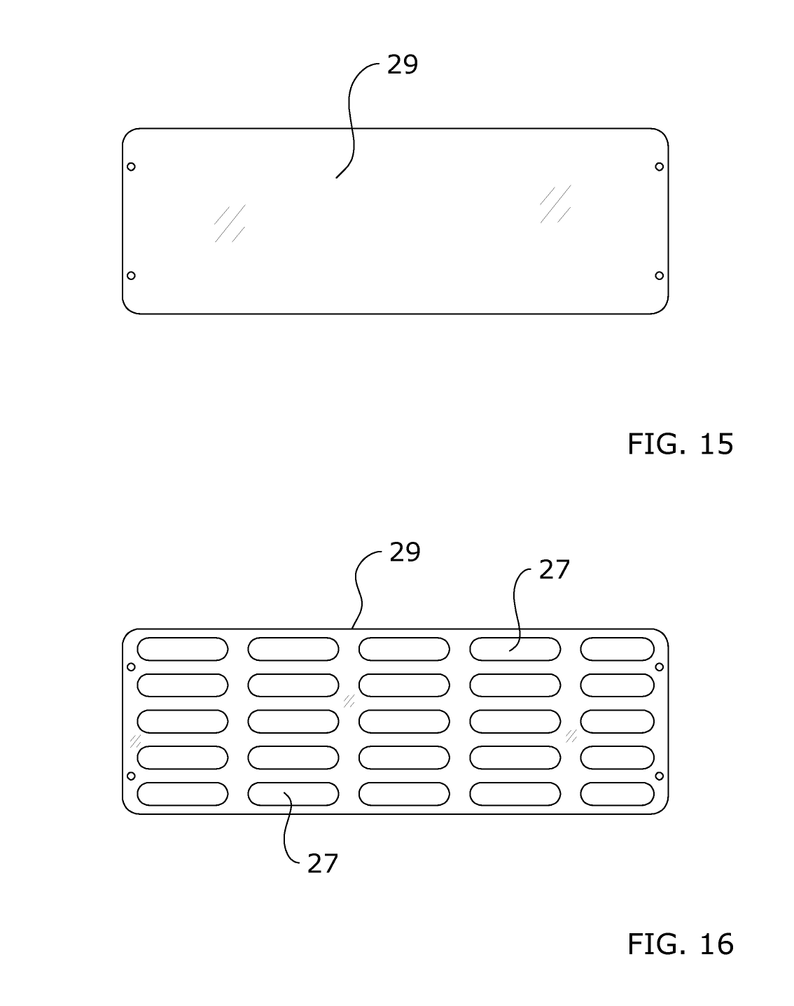

Turning now descriptively to the drawings, in which similar reference characters denote similar elements throughout the several views, FIGS. 1 through 17 illustrate a bucket mixing system 10, which comprises a bucket 20 which includes a built-in mixer adapted to mix materials and expel them through a plurality of vents 27 within the lower surface 26 of the bucket 20. A hydraulic motor 31 is secured to the bucket which drives a drive assembly 34. The drive assembly 34 is secured so as to rotate a central rod 40 from which a plurality of anchors 50 and mixers 60 extend radially. Auger linkages 72, 73 are interwoven through the anchors 50 and mixers 60 to form a flexible auger configuration. The mixers 60 may rotated bi-directionally to mix materials within the bucket 20 and to expel mixed materials through the vents 27.

### B. Bucket.

As shown throughout the figures, the present invention includes a bucket 20 which is adapted to be removably secured to a loader arm 12 of a vehicle such as an excavator. The bucket 20 may be comprised of various shapes, sizes, and configurations, and thus should not be construed as limited by the exemplary figures.

In the embodiment shown in the figures, the bucket 20 includes a front end 21, a rear end 22, a first side 23, a second side 24, an upper opening 25, and a lower surface 26. The rear end 22 of the bucket 20 includes a mounting assembly 28 which is utilized to removably secure the bucket 20 to a loader arm 12 as shown in the figures. Various types of mounting assemblies 28 known in the art for securing buckets 20 to loader arms 12 may be utilized, such as the dual-bracket configuration shown in the figures.

The upper opening 25 leads to the interior of the bucket 20. The lower surface 26 of the bucket 20 may be tapered in a hopper-like configuration, with a flat central portion and a pair of opposing, tapered walls extending diagonally from either side of the central portion. The lower surface 26 of the bucket 20 will preferably include a plurality of vents 27 through which materials will be expelled after being mixed by the mixer assembly of the present invention as discussed herein.

The sizing, numbering, and placement of the vents 27 may vary in different embodiments, as should not be construed as limited by the exemplary figures. In some embodiments, the vents 27 will be solely included on the central portion of the lower surface while in other embodiments the vents 27 will also extend along the tapered walls of the lower surface 26.

In some embodiments, an optional plate cover 29 may be included which may be utilized to block or alter the vents 27. As shown in FIGS. 16-17, the plate cover 29 is comprised of a plate or other structure which is adapted to be removably secured to the lower surface 26 of the bucket 20 to alter the vent 27 structure. The plate cover 29 may include a plurality of vents itself, or may not include vents and be a closed structure. In some cases, the plate cover 29 will include smaller vents which will fit over the vents 27 of the bucket 20 to alter their effective size. In other cases, the plate cover 29 will be solid so as to fully close off passage through the vents 27 of the bucket 20 when needed. The plate cover 29 may be secured to the bucket 20 through various means, such as through usage of fasteners.

### C. Motor.

As shown throughout the figures, the present invention includes a motor 31 which operates the mixing assembly of the present invention. The motor 31 will preferably be bi-directional so as to allow the mixers 60 of the present invention to rotate in either direction. The bucket 20 may include a motor support 30 which extends from the rear end 22 of the bucket 20 adjacent to its second side 24 as shown in the figures. The motor support 30 may be integrally formed with the bucket 20 as shown in the figures, or may be comprised of a discrete structure which is fixedly or removably secured to the bucket 20 to extend therefrom.

The motor 31 of the present invention is generally mounted on the motor support 30. In a preferred embodiment, the motor 31 will be secured to an inner wall of the motor support 30 to prevent damage to the motor 31. Various types of motors 31 will be utilized, including electric, gas, and/or hydraulic motors 31. In a preferred embodiment, a hydraulic motor 31 will be utilized which may be connected directly to the hydraulic source of the vehicle to which the bucket 20 is attached. Thus, the hydraulic conduits 32 of the vehicle may be secured directly to the motor 31.

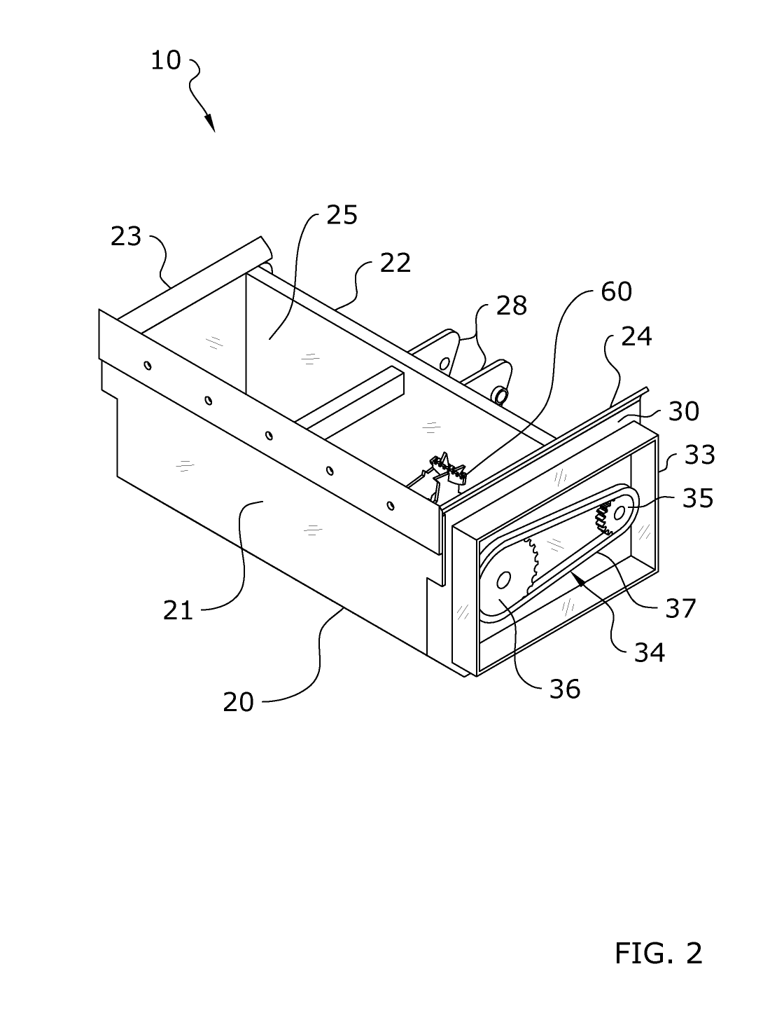

As shown in FIG. 2, the motor support 30 may also include a flange 32 on its outer wall which surrounds the drive assembly 34 of the present invention. The flange 32 will generally extend around the perimeter of the second side 24 of the bucket 20 to prevent dust, dirt, or other particulates from impacting the drive assembly 34. The drive assembly 34 of the present invention is generally positioned within the outer perimeter of the flange 32 as shown in the figures.

The drive assembly 34 of the present invention imparts rotational force from the motor 31 to the mixing assembly. The drive assembly 34 will generally comprise a first sprocket 35, a second sprocket 36, and a sprocket linkage 37 such as a chain positioned around the sprockets 35, 36. The first sprocket 35 is driven by the drive shaft of the motor 30, with the drive shaft extending through the second side 24 of the bucket 20 to connect to the first sprocket 35. The second sprocket 36 is passively rotated by the first sprocket 35 through use of the sprocket linkage 37. The second sprocket 36 is connected directly to the central rod 40 of the mixing assembly so as to rotate the central rod 40 when the first sprocket 35 is driven by the motor 31.

### D. Mixing Assembly.

The present invention utilizes a mixing assembly for mixing and breaking up any materials within the bucket 20 prior to expelling the materials through the vents 27. The mixing assembly includes a central rod 40 from which a plurality of mixers 60 extend in radially offset directions. The central rod 40 and mixers 60 are rotated by the drive assembly 34 and motor 31 as described herein.

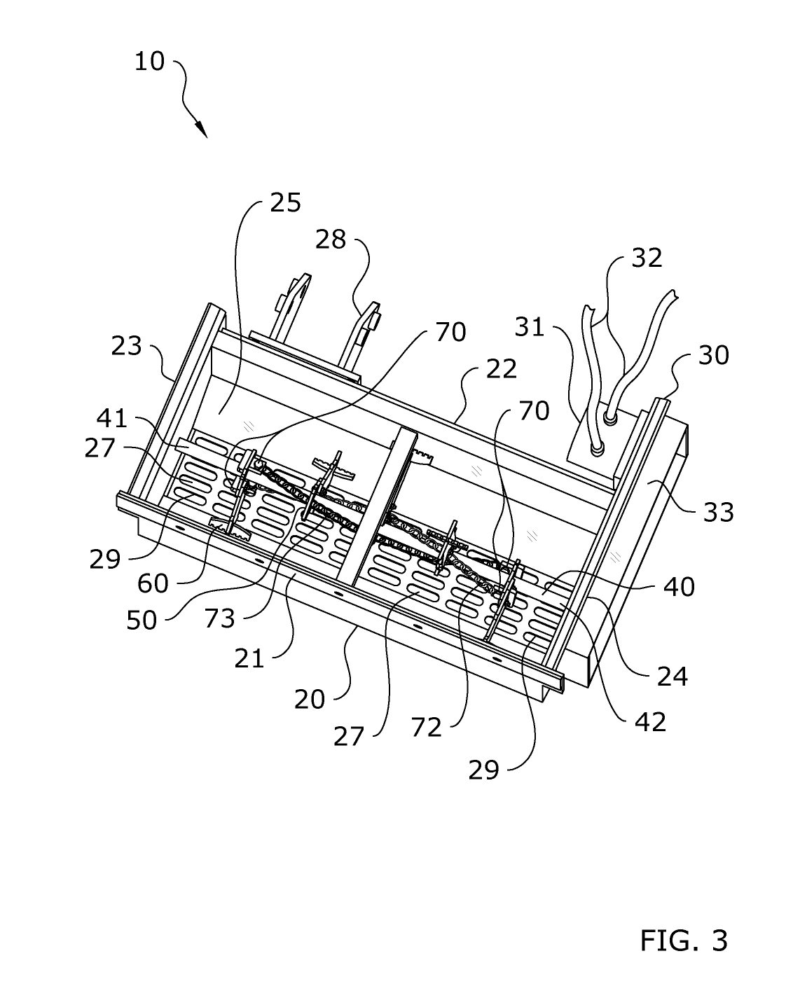

As best shown in FIG. 3, a central rod 40 extends between the first side 23 and the second side 24 of the interior of the bucket 20. The central rod 40 acts as an axle for the mixing assembly and is driven by the motor 31 and drive assembly 34. A first end 41 of the central rod 40 is rotatably secured to the first side 23 of the bucket 20. A second end 42 of the central rod 40 is linked with and rotated by the second sprocket 36, which is driven by the motor 31. The length, size, placement, and configuration of the central rod 40 may vary in different embodiments.

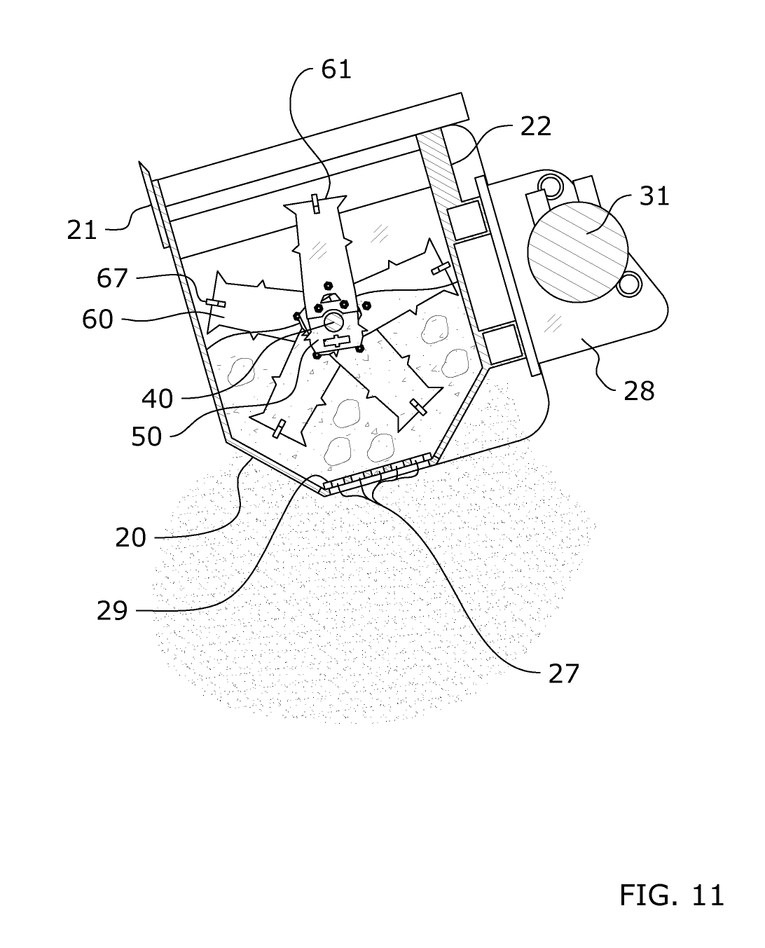

As shown in FIGS. 11-13, a plurality of anchors 50 extend radially from different locations along the length of the central rod 40. This configuration allows for different types of mixers 60 to be removably secured to the anchors 50. This configuration also allows for easy removal of the mixers 60 for cleaning or storage during times when they are not needed for operation of the bucket 20. In some embodiments, the anchors 50 may be omitted and the mixers 60 may extend directly from the central rod 40.

The anchors 50 (and, as a result, the mixers 60) are preferably secured to the central rod 40 in a stepped or staggered configuration as shown throughout the figures. By way of example, if four anchors 50 are utilized, the anchors 50 would be oriented to extend in ninety degree offset intervals (i.e. the first anchor 50 in such a set is oriented in a direction which is ninety degrees offset with respect to the adjacent second anchor 50, and so on). In a five-anchor configuration, the anchors 50 would be oriented in seventy-two degree offset intervals to create the stepped or staggered configuration.

The use of anchors 50 which are organized in a stepped fashion as shown in the figures allows a flexible auger configuration to be achieved by weaving the linkages 72, 73 through the linkage receivers 55, 56, 64 of the anchors 50 and mixers 60. The flexible auger so formed by the linkages 72, 73 will generally have a helical or spiral form.

Although not required, the diameter of the flexible auger, defined as the furthest distance between the first and second linkages 72, 73, will be less than the diameter of the mixer 60 arrangement, defined as the furthest distance between any of the mixer heads 67.

Such a stepped or staggered configuration for the anchors 50 and mixers 60 reduces the necessary power output from the motor 31. Without staggering of the anchors 50 and mixers 60, the rod 40 would stall out and stop due to weight distribution along the central rod 40. Additionally, the bi-directional nature of the motor 31 allows faster agitation and mixing of materials.

In a preferred embodiment as shown in figures, each of the anchors 50 includes a first end 51 and a second end 52. A central opening 54 is positioned at a central location between the first and second ends 51, 52. The anchors 50 are secured around the central rod 40 such that the central rod 40 extends through this central opening 54 as shown in FIG. 11.

The first end 51 of each anchor 50 will generally include a first auger linkage receiver 55 and the second end 52 of each anchor 50 will generally include a second auger linkage receiver 56. The auger linkage receivers 55, 56 will generally comprise openings which are shaped and sized so as to allow auger linkages 72, 73 to pass therethrough. On the outermost anchors 50 as shown in the figures, the auger linkage receivers 55, 56 may be adapted to removably secure ends of the auger linkages 72, 73, or may be adapted to receive auger linkage mounts 70 which are themselves adapted to removably secure ends of the auger linkages 72, 73.

The second end 52 of each anchor 50 may also include anchor attachment apertures 53a-c as shown in the figures. The anchor attachment apertures 53a-c are adapted to align with the mixer attachment apertures 63a-c of the mixers 60 to removably secure the mixers 60 to the anchors 50, such as via fasteners. In a preferred embodiment as shown in the figures, the plurality of anchor attachment apertures 53a-c comprises a first anchor attachment apertures 53a, a second anchor attachment aperture 53b and a third anchor attachment aperture 53c oriented in a triangular configuration. Alternate configurations for the anchor attachment apertures 53a-c may be utilized in different embodiments.

As shown in FIG. 11, each of the anchors 50 includes a removably secured mixer 60. The shape, size, and configuration of the mixers 60 may vary in different embodiments and should not be limited by the exemplary figures. In the preferred embodiment shown in the figures, each mixer 60 includes a first end 61 and a second end 62. The second end 62 of each mixer 60 is removably secured to the second end 52 of a corresponding anchor 50. The first end 61 of each mixer 60 includes an integrally-formed, fixedly attached, or removably attached head 67 as discussed herein.

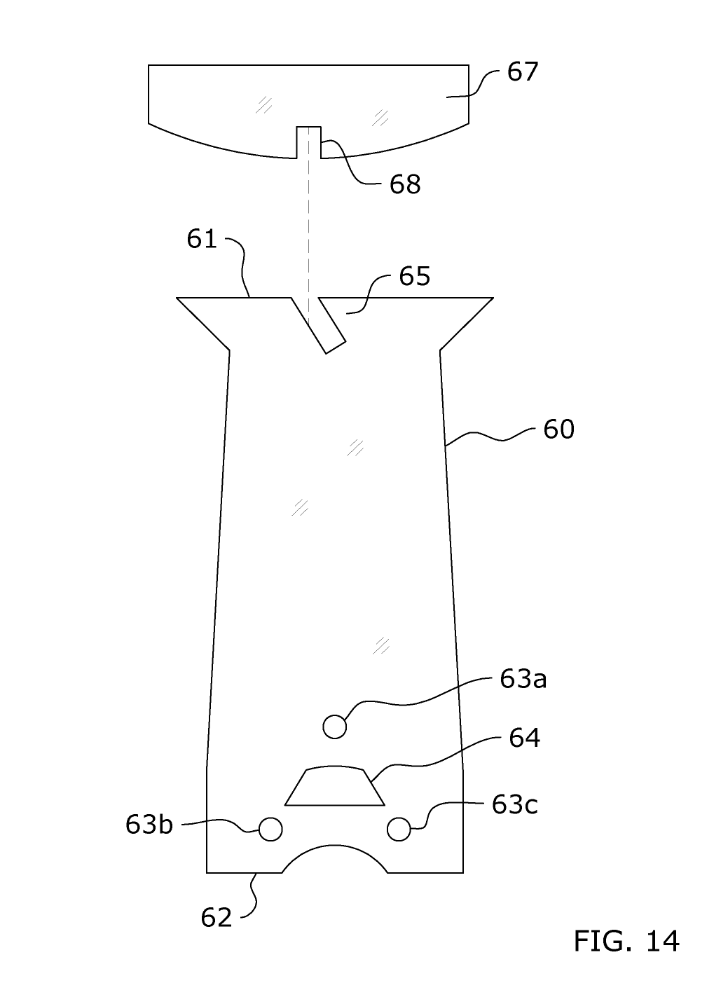

As shown in FIG. 14, each mixer includes a auger linkage receiver 64 adjacent to its second end 62 which is adapted to be aligned with the second auger linkage receiver 56 of each anchor 50 such that a auger linkage 72, 73 may extend through both receivers 56, 64 of each anchor/mixer pair simultaneously. Similarly, mixer attachment apertures 63a-c are positioned around the auger linkage receiver 64 of the mixer 60 in a pattern which mirrors the anchor attachment apertures 53a-c such that fasteners may be utilized to secure each mixer 60 to each anchor 50 utilizing the attachment apertures 53a-c, 63a-c. While alternate configurations may be utilized, a preferred embodiment of the mixer 60 includes a first mixer attachment aperture 63a, a second mixer attachment aperture 63b, and a third mixer attachment aperture 63c oriented in a triangular configuration around the auger linkage receiver 64.

In embodiments with removal heads 67, the first end 61 of the mixer 60 may include a head receiver 65 which is configured to removably secure to a corresponding head connector 68 on the head 67 itself. Various methods may be utilized, including the notches shown in the figures. Additionally, various types of heads 67 may be utilized, including heads 67 with raked outer edges and flat outer edges. The heads 67 are utilized to mix, break up, and disperse the material within the bucket 20.

Auger linkages 72, 73 are utilized to create a flexible auger configuration with the mixing assembly as shown in the figures. The auger linkages 72, 73 may be comprised of various structures, including chains, elongated cords, and steel wire cables. A first auger linkage 72 is extended through the first auger linkage receivers 55 of the anchors 50. The outermost anchors 50 will generally include auger linkage mounts 70 to which the outer ends of the first auger linkage 72 may be secured. A second auger linkage 73 is extended through the second auger linkage receivers 56 of the anchors 50 and the auger linkage receivers 64 of the mixers 60, with the outer ends of the second auger linkage 73 being similarly secured to the outermost anchors 50, such as via use of auger linkage mounts 70.

### E. Operation of Preferred Embodiment.

In use, the bucket 20 is first secured to a lifting arm 12 and the hydraulic conduits 33 are connected to the motor 31. If not yet assembled, the anchors 50 will first be secured around the central rod 40. The mixers 60 may then be secured to each of the anchors 50 and a head-type may be selected. The appropriate head 67 may then be secured to the mixers 60 using the head receivers 65 and head connectors 68. The auger linkages 72, 73 may then be installed through the auger linkage receivers 55, 56, 64 and anchored to the outermost anchors 50 to form a flexible auger.

The bucket 20 may be manipulated and positioned to scoop materials such as oil well waste mud using the lifting arm 12. Stabilizing agents are added to these scooped materials to stabilize the scooped materials (often such materials include high salinity or other undesirable chemical properties). Stabilizing agents may include fly ash or chunks of brine water, etc.

As materials are scooped into the bucket 20, the mixing assembly 60 may be activated by directing hydraulic flow to the motor 31 from the vehicle. The central rod 40 will rotate, causing the mixers 60 to pass through and mix up the scooped materials and stabilizing agents within the bucket 20. The heads 67 of each mixer 60 will scrape the interior walls of the bucket 20 to keep material from building up and caking over the interior of the bucket 20. The auger linkages 72, 73 will act as a flexible auger to aid passage of the materials throughout the bucket 20.

The mixed materials will be expelled from the bucket 20 through the vents 27 as shown in FIG. 11. The shape and size of the vents 27 may be altered for different types of materials by selectively affixing a plate cover 29 over the vents 27. If it is desired not to expel any of the materials at a certain time, the solid plate cover 29 may be affixed over the vents 27 to thus close the vents 27 and keep the material circulating within the bucket 20 without being expelled.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. A bucket mixing system, comprising:
a bucket adapted to be secured to a loading arm;
a motor mounted to said bucket;
a drive assembly connected to said motor, wherein said drive assembly includes a central rod extending within said bucket, wherein said central rod is rotated by said motor; and
a plurality of mixers extending from said central rod.

2. The bucket mixing system of claim 1, wherein said motor is comprised of a hydraulic motor.

3. The bucket mixing system of claim 1, wherein said drive assembly includes a first sprocket, a second sprocket, and a sprocket linkage between said sprockets.

4. The bucket mixing system of claim 3, wherein said first sprocket is connected to said motor.

5. The bucket mixing system of claim 4, wherein said second sprocket is connected to said central rod.

6. The bucket mixing system of claim 1, wherein each of said mixers includes an anchor.

7. The bucket mixing system of claim 6, wherein each of said anchors includes a central opening and at least one auger linkage receiver.

8. The bucket mixing system of claim 7, wherein each of said mixers is removably secured to one of said anchors.

9. The bucket mixing system of claim 8, wherein said central opening of each of said anchors extends around said central rod.

10. The bucket mixing system of claim 9, wherein said each of said mixers includes a head.

11. The bucket mixing system of claim 10, wherein said head includes a raked outer edge.

12. The bucket mixing system of claim 11, wherein each of said heads is removably attached to one of said mixers.

13. The bucket mixing system of claim 1, further comprising a plate cover for securing over said lower surface of said bucket.

14. The bucket mixing system of claim 13, wherein said plate cover includes a plurality of vents, wherein said plurality of vents of said plate cover are smaller than said plurality of vents of said bucket.

15. The bucket mixing system of claim 7, further comprising a first auger linkage extending through said anchors.

16. The bucket mixing system of claim 15, further comprising a second auger linkage extending through said anchors to form a helical flexible auger with said first auger linkage.

17. The bucket mixing system of claim 1, wherein a rear end of said bucket includes a mounting assembly for mounting to said loading arm.

18. The bucket mixing system of claim 1, further comprising a motor support extending from a first side of said bucket.

19. The bucket mixing system of claim 18, wherein said motor is secured to a first side of said motor support and said drive assembly is secured to a second side of said motor support.

20. The bucket mixing system of claim 19, further comprising a flange on said second side of said motor support surrounding said drive assembly.
